(19) United States
(12) Patent Application Publication
(10) Pub. No.: US 2008/0147858 A1
(43) Pub. Date: Jun. 19, 2008

(54) Distributed Out-of-Band (OOB) OS-Independent Platform Management

(76) Inventors: Ramkrishna Prakash, Austin, TX (US); William F. Sauber, Georgetown, TX (US); Ronald D. Shaw, Austin, TX (US); Abeye Teshome, Austin, TX (US)

Correspondence Address: HAMILTON & TERRILE, LLP, P.O. BOX 203518, AUSTIN, TX, 78720, US

(21) Appl. No.: 11/609,968

(22) Filed: Dec. 13, 2006

(51) Int. Cl. G06F 15/173; G06F 15/16

(52) U.S. Cl. 709/225; 709/230

(57) ABSTRACT

A system and method is disclosed for a distributed out-of-band (OOB) management controller system enabling efficient usage of power while providing multiple methods and levels of communication between intelligent devices. Two or more management controllers collaboratively operate in a predetermined manner including, but not limited to, peer-to-peer, master/slave, or independently. Management information consistency is maintained across a system's power states by implementing distributed intelligent devices that directly interact as communication devices to local or remote management consoles. A management protocol is implemented such that management information is communicated between managed elements and management controllers over physical interfaces or via a network connection. A first management controller is implemented to communicate with managed elements via a bus that is available only when the system is under full power and a second controller is implemented to communicate with the same managed elements for most power states, including low power. The second management controller remains operable to generate simple management information packets or use packets stored in communications devices to generate primitive or higher-level alert functions.

### BACKGROUND OF THE INVENTION

1. Field of the Invention

The present invention relates in general to the field of information handling systems and more specifically, to management of information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems continue to grow in power and complexity while shrinking in size. As these systems become more powerful, it is common to have a parallel increase in the number of system components and subsystems that require management. At the same time, reduction in size generally requires a corresponding decrease in the amount of power consumption, especially when implemented in battery operated or mobile form factors. One approach to management of a large number of systems or components is implementation of out-of-band (OOB) management methods, which uses alternate channels of communication for the transfer of management information. However, current implementations of OOB management controllers typically require being in an ‘on’ state, such that they are available to communicate with a remote management console to send and receive management information. When required to be in an ‘on’ state, they consume power even if the system itself is in an idle state.

Furthermore, since these management controllers are architected on a centralized ownership model, information collection and transfer to remote applications is generally the responsibility of a single intelligent device. These devices include, but are not limited to, a baseboard management controller (BMC), a remote access controller (RAC), or a chassis manager for a blade system. As such, the use of OOB management controllers has historically been oriented to systems such as servers, disk storage arrays, network switches, etc., whose operational behavior as well as design enable them to operate under dedicated power. However, these management controllers are now being implemented in desktop computers, mobile platforms and other devices. Many of these are not capable of high bandwidth communications and are not always able to accommodate these design and behavioral conditions. In addition, the current centralized and always-on approach to OOB management controllers presents other challenges.

For example, centralization of platform management intelligence results in a complex management controller architecture that is burdened with the overhead of dealing with the different communications mechanisms associated with each management target. Furthermore, the management controller must have predetermined knowledge of the existence of all platform-level components as well as the ability to manage the diagnosis, configuration, servicing and maintenance of those components. As another example, the requirement for management controllers to remain in an “always on” state fails to address the management and energy considerations for mobile and distributed platforms. Current implementations of architectures such as Intelligent Platform Management Interface (IMPI) and System Management Bus (SMBus) that implement management controllers in a master/slave relationship do not address these issues. The same issues are encountered in implementations that include unique interfaces to support management and diagnostic requirements for each driver, such as built-in self-test (BIST) for intelligent devices and temperature sensors. In other approaches, physical standards such as SMBus are implemented for communication of management information between physically co-resident components and controllers. Furthermore, none of these provide peer-to-peer management controller relationships, nor are they able to operate in a low power state.

### SUMMARY OF THE INVENTION

In accordance with the present invention, a system and method is disclosed for a distributed out-of-band (OOB) management controller system enabling efficient usage of power while providing multiple methods and levels of communication between intelligent devices. In different embodiments of the invention, two or more management controllers collaboratively operate in a predetermined manner including, but not limited to, peer-to-peer, master/slave, or independently. In an embodiment of the invention, management information consistency is maintained across a system's power states by implementing distributed intelligent devices that directly interact as communication devices to a local or remote management console. In one embodiment of the invention, a management protocol is implemented such that management information is communicated between managed elements and management controllers over physical interfaces such as, but not limited to, PCIe, SMBus, or other physical interfaces. In another embodiment of the invention, a first management controller communicates with managed elements via a PCIe bus and communicates with a second management controller via a second interface such as, but not limited to, SMBus. In another embodiment of the invention, the first management controller communicates with managed elements as well as a second management controller via a PCIe bus. In yet another embodiment of the invention, a management protocol is implemented such that management information is communicated between management controllers that are not physically co-resident via a network connection implementing a network protocol such as, but not limited to, Ethernet.

In an embodiment of the invention, an OOB management controller system is implemented on a mobile computing platform such as a laptop computer or personal digital assistant (PDA). In this embodiment, a first management controller collaboratively operates through one or more interfaces with a second management controller in a predetermined manner including peer-to-peer, master/slave, or independently, to manage subsystems comprising the mobile computing platform. In this same embodiment of the invention, the first management controller communicates with managed elements via a bus that is available only under predetermined power states. These elements include, but are not limited to, a wireless local area network (LAN) input/output (I/O) controller, wired LAN I/O controller, or other I/O controller elements such as disk storage I/O, redundant array of independent disk (RAID) controllers, etc. For example, unless the system is under full power, the first controller is not able to communicate with the elements via its default bus. Conversely, the second management controller is implemented to communicate with the same managed elements for most power states, including low power.

In one embodiment of the invention, predetermined policies associated with a platform reside in the second management controller but not the first management controller. For example, alert logic comprising alert policies of a system component are conveyed only to the second management controller. In an embodiment of the invention, a distributed OOB management controller is implemented to maintain operational functionality under predetermined power states. For example, a distributed OOB management controller is embedded in a laptop computer and remains operational when the laptop is not fully powered. In this example, the management controller remains operable to generate simple management information packets or use packets stored in communications devices to generate primitive or higher-level alert functions. Similarly, when the computer is in a powered-down state, a predetermined management packet can be communicated to cause the system to be awakened.

In one embodiment of the invention, existing general purpose I/O communications paths such as peripheral component interconnect express (PCIe) and SMBus are implemented to convey system management information. In another embodiment of the invention, multiple management controllers communicate with a remote management application to preserve the state of management information. In another embodiment of the invention, two or more distributed OOB management controllers are implemented to collaboratively operate as a single management entity. In this embodiment, session characteristics are preserved and security is not compromised when communicating with remote management applications. In different embodiments of the invention, communications between distributed OOB management controllers and remote management applications can be as rudimentary as passing tokens that contain relevant management information. Likewise, more elaborate communications protocols can be implemented for communications between the management controllers. The mode of communication between management controllers is dependent upon their implemented capabilities and the power state available. Those of skill in the art will understand that many such embodiments and variations of the invention are possible, including but not limited to those described hereinabove, which are by no means all inclusive.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the method and apparatus of the present invention;

FIG. 2 is a generalized block diagram illustrating a system managed by a prior art first management controller implemented with a first interface;

FIG. 3 is a generalized block diagram of a system managed by a first management controller and a second management controller coupled by a second interface as implemented in accordance with an embodiment of the invention;

FIG. 4 is a generalized block diagram of a system managed by a first and second management controller coupled by a first and second interface in accordance with an embodiment of the invention;

FIG. 5 is a generalized block diagram of a managed system managed by a second management controller implemented with alert logic in accordance with an embodiment of the invention; and

FIG. 6 is a generalized block diagram of a managed system managed by a remotely administered second management controller implemented in accordance with an embodiment of the invention to maintain operational functionality under predetermined power states.

### DETAILED DESCRIPTION

A system and method is disclosed for a distributed out-of-band (OOB) management controller system enabling efficient usage of power while providing multiple methods and levels of communication between intelligent devices. In different embodiments of the invention, two or more management controllers collaboratively operate in a predetermined manner including, but not limited to, peer-to-peer, master/slave, or independently. Management information consistency is maintained across a system's power states by implementing distributed intelligent devices that directly interact as communication devices to a local or remote management console. In these embodiments of the invention, a management protocol is implemented such that management information is communicated between managed elements and management controllers over physical interfaces or via a network connection.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

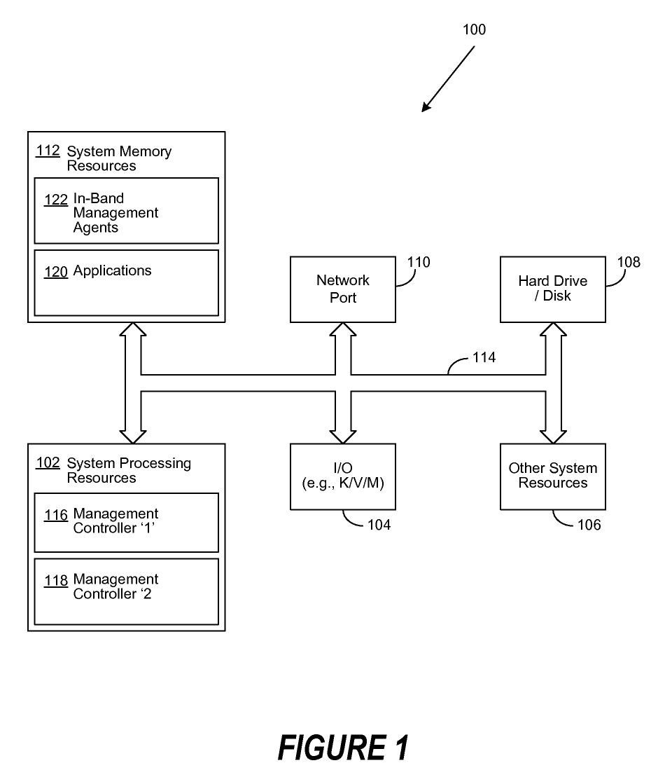

FIG. 1 is a generalized illustration of an information handling system 100 that can be used to implement the system and method of the present invention. The information handling system comprises system processing resources 102, input/output (I/O) devices 104, such as a display, a keyboard, a mouse, and associated controllers, a hard disk drive 106, other system resources 108, such as a floppy disk and drive and other memory devices, network port 110, and system memory resources 112, all interconnected via one or more buses 114. In one embodiment of the invention, system processing resources 102 comprise a management controller ‘1’ 116 and management controller ‘2’ 118 and system memory resources 112 comprise applications 120 and in-band management agents 122.

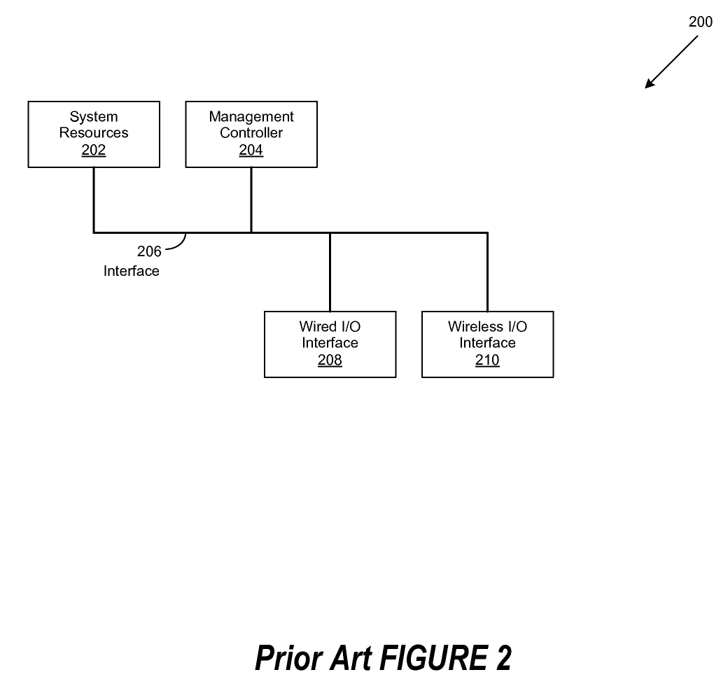

FIG. 2 is a generalized block diagram illustrating a managed system 200 managed by prior art management controller 204 as implemented with a first interface 206. Management information and commands are communicated via bus interface 206 between management controller 204, managed elements wired I/O interface 208, wireless I/O interface 210, and system resources 202. Bus interface 206 comprises a physical interface such as, but not limited to, peripheral component interface express (PCIe).

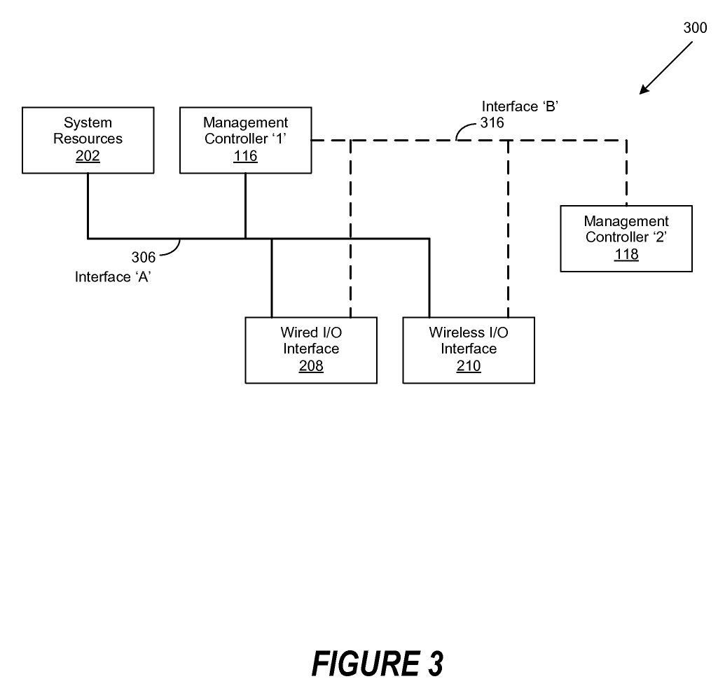

FIG. 3 is a generalized block diagram of a managed system 300 managed by a first management controller and a second management controller coupled by a second interface as implemented in accordance with an embodiment of the invention. In this embodiment, management controller ‘1’ 116 and management controller ‘2’ 118 are coupled by interface ‘B’ 316. Management controller ‘2’ 118 comprises a distributed out-of-band (OOB) management controller enabling efficient usage of power while providing multiple methods and levels of communication between intelligent devices. Management information and commands are communicated via interface ‘A’ 306 between management controller ‘1’ 116, managed elements wired I/O interface 208, wireless I/O interface 210, and system resources 202. Interface ‘A’ 306 comprises a physical interface such as, but not limited to, peripheral component interface express (PCIe). Management information and commands are similarly communicated via interface ‘B’ 316 between management controller ‘2’ 118, managed elements wired I/O interface 208, wireless I/O interface 210, and management controller ‘1’ 116. Interface ‘B’ 316 comprises a physical interface such as, but not limited to, system management bus (SMBus).

Management controller ‘1’ 304 and management controller ‘2’ 314 are implemented to collaboratively operate in a predetermined manner including peer-to-peer, master/slave, or independently. In another embodiment of the invention, management controller ‘1’ 116 is implemented to communicate with managed elements wired I/O interface 208, wireless I/O interface 210, and other system resources 202 via interface ‘A’ 306 only when the system they comprise is under full power. Conversely, management controller ‘2’ 118 is implemented to communicate with managed elements wired I/O interface 208, wireless I/O interface 210, and management controller ‘1’ 116 via interface ‘B’ 316 for most power states, including low power.

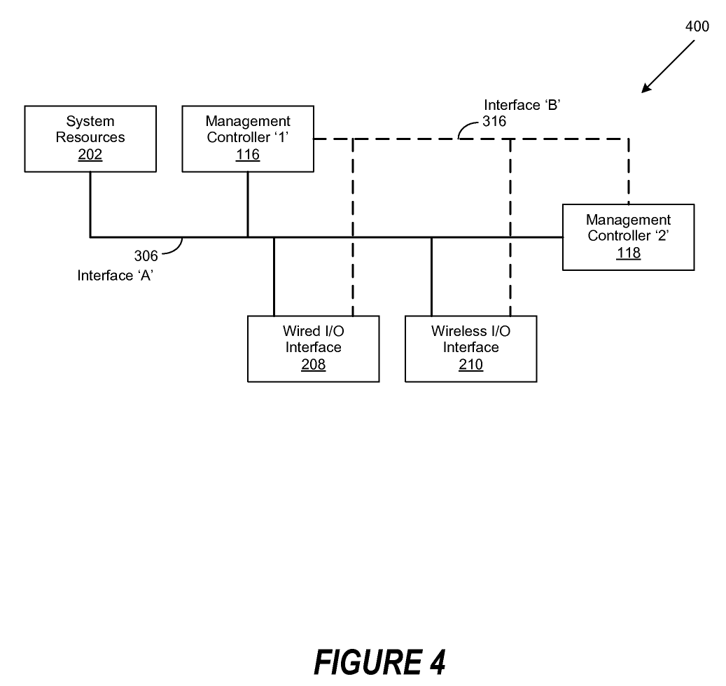

FIG. 4 is a generalized block diagram of a system 400 managed by a first and second management controller coupled by a first and a second interface in accordance with an embodiment of the invention. In selected embodiments, management controller ‘1’ 116 and management controller ‘2’ 118 are implemented to collaboratively operate in a predetermined manner including, peer-to-peer, master/slave, or independently. In these embodiments, management controller ‘1’ 116 and management controller ‘2’ 118 are coupled by interface ‘A’ 306 and interface ‘B’ 316. In another embodiment, management controller ‘1’ 116 and management controller ‘2’ 118 collaboratively operate with each other peer-to-peer and with managed devices using only interface ‘A’ 306. In yet another embodiment, management controller ‘1’ 116 and management controller ‘2’ 118 collaboratively operate with each other peer-to-peer and with managed devices using only interface ‘B’ 316. In another embodiment, management controller ‘1’ 116 and management controller ‘2’ 118 collaboratively operate with each other peer-to-peer and with managed devices using both interface ‘A’ 306 and interface ‘B’ 316 concurrently.

Implementation of interface ‘A’ 306 and interface ‘B’ 316 enables efficient usage of power while providing multiple methods and levels of communication between intelligent devices. Management information and commands are communicated via interface ‘A’ 306 between management controller ‘1’ 116, management controller ‘2’ 118, managed elements wired I/O interface 208, wireless I/O interface 210, and system resources 202. Management information and commands are likewise communicated via interface ‘B’ 316 between management controller ‘2’ 118, managed elements wired I/O interface 208, wireless I/O interface 210, and management controller ‘1’ 116.

Management controller ‘1’ 116 and management controller ‘2’ 118 are implemented to collaboratively operate in a predetermined manner including peer-to-peer, master/slave, or independently with no hierarchy implied by their respective designations. In one embodiment of the invention, management controller ‘1’ 116 is implemented to communicate with management controller ‘2’ 118, managed elements wired I/O interface 208, wireless I/O interface 210, and system resources 202 via interface ‘A’ 306 only when the system they comprise is under full power. Conversely, management controller ‘2’ 118 is implemented to communicate with managed elements wired I/O interface 208, wireless I/O interface 210, and management controller ‘1’ 116 via interface ‘B’ 316 for most power states, including low power.

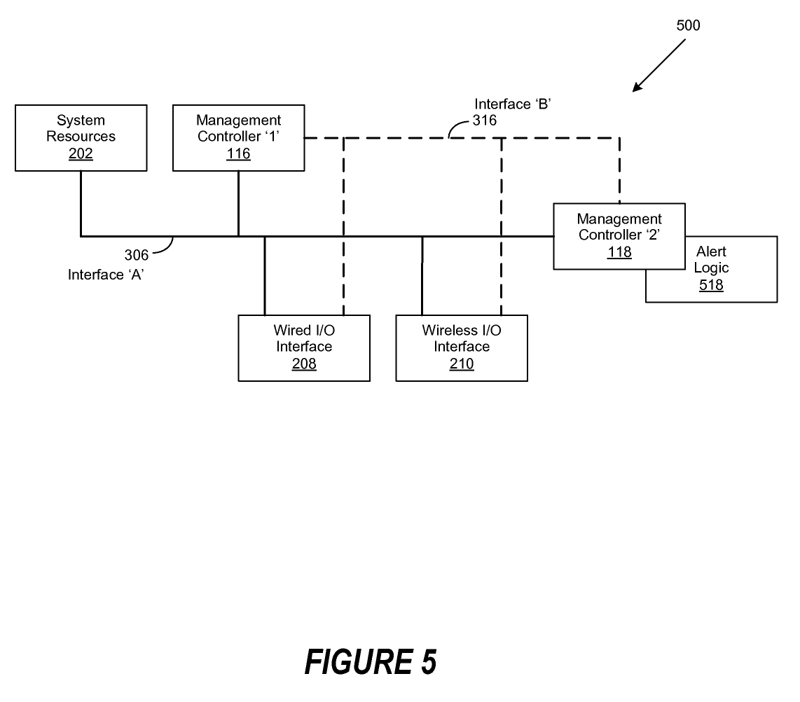

FIG. 5 is a generalized block diagram of a managed system 500 managed by a second management controller implemented with alert logic 518 in accordance with an embodiment of the invention. In selected embodiments, management controller ‘1’ 116 and management controller ‘2’ 118 are implemented to collaboratively operate in a predetermined manner including, peer-to-peer, master/slave, or independently. In these embodiments, management controller ‘1’ 116 and management controller ‘2’ 118 are coupled by interface ‘A’ 306 and interface ‘B’ 316. In another embodiment, management controller ‘1’ 116 and management controller ‘2’ 118 collaboratively operate with each other peer-to-peer and with managed devices using only interface ‘A’ 306. In yet another embodiment, management controller ‘1’ 116 and management controller ‘2’ 118 collaboratively operate with each other peer-to-peer and with managed devices using only interface ‘B’ 316. In another embodiment, management controller ‘1’ 116 and management controller ‘2’ 118 collaboratively operate with each other peer-to-peer and with managed devices using both interface ‘A’ 306 and interface ‘B’ 316 concurrently.

Implementation of interface ‘A’ 306 and interface ‘B’ 316 enables efficient usage of power while providing multiple methods and levels of communication between intelligent devices. Management information and commands are communicated via interface ‘A’ 306 between management controller ‘1’ 116, management controller ‘2’ 118, managed elements wired I/O interface 208, wireless I/O interface 210, and system resources 202. Management information and commands are likewise communicated via interface ‘B’ 316 between management controller ‘2’ 118, managed elements wired I/O interface 208, wireless I/O interface 210, and management controller ‘1’ 116.

Management controller ‘1’ 116 and management controller ‘2’ 118 are implemented to collaboratively operate in a predetermined manner including, peer-to-peer, master/slave, or independently with no hierarchy implied by their respective designations. In one embodiment of the invention, management controller ‘1’ 116 is implemented to communicate with management controller ‘2’ 118, managed elements wired I/O interface 208, wireless I/O interface 210, and system resources 202 via interface ‘A’ 306 only when the system they comprise is under full power. Conversely, management controller ‘2’ 118 is implemented to communicate with managed elements wired I/O interface 208, wireless I/O interface 210, alert logic 518 and management controller ‘1’ 116 via interface ‘B’ 316 for a plurality of power states, including low power. In this embodiment, alert logic 518 comprises predetermined management policies which are communicated to managed elements wired I/O interface 208, wireless I/O interface 210, by management controller ‘2’ 118. For example, alert logic comprising alert policies of a system component are conveyed only by management controller ‘2’ 118, which is operable to function when the system is in a low power state, and not management controller ‘1’ 116.

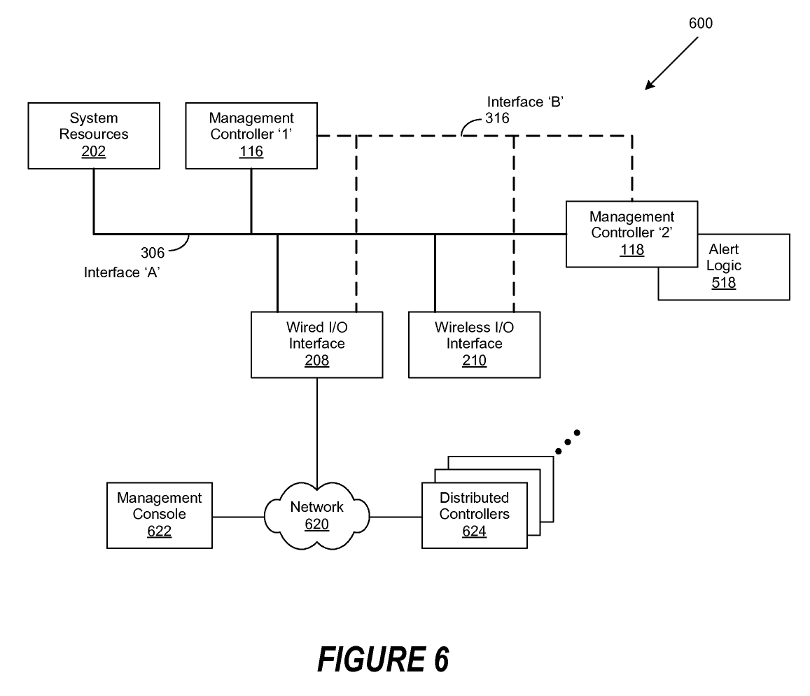

FIG. 6 is a generalized block diagram of a managed system 600 managed by a remotely administered management controller 624, that may comprise a plurality of distributed controllers 626. The embodiment shown in FIG. 6 can be implemented in accordance with an embodiment of the invention to maintain operational functionality under predetermined power states. In selected embodiments, management controller ‘1’ 116 and management controller ‘2’ 118 are implemented to collaboratively operate in a predetermined manner including peer-to-peer, master/slave, or independently. In these embodiments, management controller ‘1’ 116 and management controller ‘2’ 118 are coupled by interface ‘A’ 306 and interface ‘B’ 316. In another embodiment, management controller ‘1’ 116 and management controller ‘2’ 118 collaboratively operate with each other peer-to-peer and with managed devices using only interface ‘A’ 306. In yet another embodiment, management controller ‘1’ 116 and management controller ‘2’ 118 collaboratively operate with each other peer-to-peer and with managed devices using only interface ‘B’ 316. In another embodiment, management controller ‘1’ 116 and management controller ‘2’ 118 collaboratively operate with each other peer-to-peer and with managed devices using both interface ‘A’ 306 and interface ‘B’ 316 concurrently.

Implementation of interface ‘A’ 306 and interface ‘B’ 316 enables efficient usage of power while providing multiple methods and levels of communication between intelligent devices. Management information and commands are communicated via interface ‘A’ 306 between management controller ‘1’ 116, management controller ‘2’ 118, managed elements wired I/O interface 208, wireless I/O interface 210, and system resources 202. Management information and commands are likewise communicated via interface ‘B’ 316 between management controller ‘2’ 118, managed elements wired I/O interface 208, wireless I/O interface 210, and management controller ‘1’ 116. In this embodiment of the invention, management controller ‘2’ 118 generates simple management information packets, or use packets stored in communications devices 208, 210 to generate primitive or higher-level alert functions, when the system is not fully powered.

In one embodiment of the invention, a management protocol is implemented such that management information is communicated between managed elements and management controllers over physical interfaces such as PCIe, SMBus, and others. In another embodiment of the invention, a management protocol is implemented such that management information is communicated between management controller ‘2’ 118, distributed controllers 626, and remote management console 622 via network 620 by implementing a network protocol such as, but not limited to, Ethernet. In another embodiment of the invention, management controller ‘2’ 118 and distributed controllers 626 communicate with remote management console 622 via network 620 such that the state of management information and session characteristics are preserved and security is uncompromised. In selected embodiments of the invention, communications between management controller ‘2’ 118, distributed controllers 626 and remote management console 622 can be as rudimentary as passing tokens that contain relevant management information. Likewise, more elaborate communications protocols can be implemented for communications between management controller ‘2’ 118, distributed controllers 626, and remote management console 622, with the communication mode dependent upon their implemented capabilities and the power state available.

In an embodiment of the invention, management controller ‘2’ 118 is implemented to directly interact as a communication device to local or remote management console 622 via network 620 to maintain management information consistency across a system's power states, including low power. In this embodiment, alert logic 518 comprises predetermined management policies which are communicated to managed elements wired I/O interface 208, wireless I/O interface 210, by management controller ‘2’ 118. For example, alert logic comprising alert policies of a system component are conveyed only by management controller ‘2’ 118, which is operable to function when the system is in a low power state, and not management controller ‘1’ 116. When the system is in a powered-down state, a predetermined management packet is communicated from management console 622 via network 620 to management controller ‘2’ 118, comprising alert logic 518, that causes the system to be awakened.

Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

What is claimed is:

1. A system for managing a plurality of devices in one or more information handling systems, comprising:
a first management controller;
a second management controller;
a plurality of managed elements;
a first interface operable to provide communication between said first and second management controllers and said managed elements; and
processing logic operable to implement a management protocol whereby said first and second management controllers are operable to communicate over said first interface to control said plurality of managed elements.

2. The system of claim 1, wherein said first and second management controllers are configured to communicate using a peer-to-peer protocol.

3. The system of claim 1, wherein said first and second management controllers are configured to communicate using a master-slave protocol.

4. The system of claim 1, wherein said first and second management controllers are operable to communicate over a network using a distributed communication protocol.

5. The system of claim 1, wherein said system further comprises:
a second interface operably coupled to said first and second management controllers, wherein said first and second management controllers are operable to communicate using said second interface and further operable to control a plurality of managed elements coupled to said second interface.

6. The system of claim 5, wherein said first and second interfaces are coupled to said first and second management controllers, said first and second management controllers operable to communicate with each other using said first and second interfaces and further operable to collaboratively control a plurality of managed elements operably coupled to said first and second interfaces.

7. The system of claim 6, wherein said second management controller comprises alert logic further comprising predetermined management policies, said plurality of managed elements operable to be controlled by said second management controller communicating said predetermined management policies to said plurality of managed elements operably coupled to said first interface and said second interface.

8. The system of claim 5, wherein said second management controller is operable to change the power state of said managed elements based on predetermined alert policies.

9. The system of claim 8, wherein said first and second buses are operable only with predetermined power states.

10. The system of claim 8, wherein said second bus is operable to enable communication with said managed elements when said managed elements are operating at a low power state.

11. A method of managing a plurality of devices in one or more information handling systems, comprising:
using a first interface to provide communication between first and second management controllers and said plurality of devices; and
using processing logic to implement a management protocol whereby said first and second management controllers are operable to communicate over said first interface to control said plurality of managed elements.

12. The method of claim 11, wherein said first and second management controllers are configured to communicate using a peer-to-peer protocol.

13. The method of claim 1 1, wherein said first and second management controllers are configured to communicate using a master-slave protocol.

14. The method of claim 11, wherein said first and second management controllers are operable to communicate over a network using a distributed communication protocol.

15. The method of claim 11, wherein said method further comprises:
operably coupling said first and second management controllers to a second interface, wherein said first and second management controllers communicate using said second interface and control a plurality of managed elements coupled to said second interface.

16. The method of claim 15, wherein said first and second interfaces are coupled to said first and second management controllers, said first and second management controllers operable to communicate with each other using said first and second interfaces and further operable to collaboratively control a plurality of managed elements operably coupled to said first and second interfaces.

17. The method of claim 16, wherein said second management controller comprises alert logic further comprising predetermined management policies, said plurality of managed elements operable to be controlled by said second management controller communicating said predetermined management policies to said plurality of managed elements operably coupled to said first interface and said second interface.

18. The method of claim 15, wherein said second management controller is operable to change the power state of said managed elements based on predetermined alert policies.

19. The method of claim 18, wherein said first and second buses are operable only with predetermined power states.

20. The method of claim 18, wherein said second bus is operable to enable communication with said managed elements when said managed elements are operating at a low power state.
